(19) United States
(12) Patent Application Publication
(10) Pub. No.: US 2025/0005642 A1
(43) Pub. Date: Jan. 2, 2025

(54) ACCURATE IDENTIFICATION OF VISUALLY SIMILAR ITEMS

(71) Applicant: ZEBRA TECHNOLOGIES CORPORATION, Lincolnshire, IL (US)

(72) Inventors: Yuri Astvatsaturov, Lake Forest, IL (US); Darran Michael Handshaw, Sound Beach, NY (US); Edward Barkan, Miller Place, NY (US)

(21) Appl. No.: 18/217,424

(22) Filed: Jun. 30, 2023

(51) Int. Cl. G06Q 30/0601

(52) U.S. Cl. CPC G06Q 30/0629; G06Q 30/0643; G06Q 20/208

(57) ABSTRACT

Techniques for item processing within a space are disclosed herein. An example method includes receiving item-identification data, the item-identification data based on vision data captured by a machine vision component and/or a user-provided data captured by a user interface; receiving, via the user interface, input from a user indicating a selected item category for the item; determining, based on the item-identification data and the selected category, at least one of: (i) the user visited a location within the space associated with items in the selected category; or (ii) the user did not visit the location within the space associated with the items in the selected category; responsive to determining (i), generating, by the processor, a first response signal associated with the item; and responsive to determining (ii), generating, by the processor, a second response signal associated with the item including an alert signal associated with an item mismatch.

### BACKGROUND

The differences between certain categories of items (or certain sub-categories of the same item) may not always be visually discernible. For example, organic produce may be visually identical to non-organic produce. As another example, two varieties of a particular category of produce (e.g., Honeycrisp apples and Fuji apples) may be visually indistinguishable from one another. Accordingly, there is a need for systems and methods for accurate identification of such items.

### SUMMARY

In an embodiment, the present invention is a method of item processing within a space comprising: receiving, at a processor, item-identification data, the item-identification data being based on at least one of vision data captured by a machine vision component or a user-provided data captured by a user interface; receiving, at the processor and via the user interface, input from a user indicating an item category for the item resulting in a selected category; determining, based at least in part on the item-identification data and the selected category, at least one of: (i) the user visited a location within the space associated with items in the selected category; or (ii) the user did not visit the location within the space associated with the items in the selected category; responsive to determining (i), generating, by the processor, a first response signal associated with the item; and responsive to determining (ii), generating, by the processor, a second response signal associated with the item including an alert signal associated with an item mismatch.

In a variation of this embodiment, receiving the input from the user indicating the item category for the item resulting in the selected category includes selecting the item category from a plurality of categories, each of the plurality of categories being associated with a same genus and a different species of the item.

Additionally, in a variation of this embodiment, receiving the input from the user indicating the item category for the item resulting in the selected category includes selecting the item category from a plurality of categories, each of the plurality of categories being associated with a same appearance and a different chemical composition of the item.

Furthermore, in a variation of this embodiment, the machine vision component is a component of an indicia reader.

Moreover, in a variation of this embodiment, determining the at least one of further includes (iii) the user visited another location within the space associated with items in a non-selected category, and the method further includes, responsive to determining (iii), providing, via the user interface, an option allowing the user to change the item category from the selected category to the non-selected category.

Additionally, in a variation of this embodiment, the method further comprises detecting, at the processor, an identifying characteristic associated with the user, and the determining the at least one of (i) or (ii) is further based at least in part on the identifying characteristic associated with the user.

Furthermore, in a variation of this embodiment, the method further comprises capturing positional data associated with the identifying characteristic during at least some duration that the user is present within the space.

Moreover, in a variation of this embodiment, the processor is a component of an indicia reader, and the method further comprises: determining the identifying characteristic associated with the user prior to the user being within interactable proximity with the indicia reader; and subsequent to determining the identifying characteristic and before the user being within interactable proximity with the indicia reader, capturing the positional data associated with the identifying characteristic.

Additionally, in a variation of this embodiment, the identifying characteristic associated with the user includes at least one of a visual feature associated with the user, an identifier associated with an item carrier operated by the user, or a mobile device profile associated with the user.

Furthermore, in a variation of this embodiment, the first response signal includes transmission of item-identifying data to a host.

Moreover, in a variation of this embodiment, the alert signal includes a prevention of the transmission of the item-identifying data to the host until a release trigger is received at the processor.

Additionally, in a variation of this embodiment, the method further comprises determining: (iv) the user removed an item from the space associated with a selected category; (v) the user did not remove an item from the space associated with the selected category; or (vi) the user reached for an item in the space associated with a selected category; and generating the first response signal or the second response signal is responsive to the determination of (iv), (v), or (vi).

In another embodiment, the present invention is system for item processing within a space comprising: one or more processors; and a memory storing instructions that, when executed by the one or more processors, cause the one or more processors to: receive item-identification data, the item-identification data being based on at least one of vision data captured by a machine vision component or a user-provided data captured by a user interface; receive, via the user interface, input from a user indicating an item category for the item resulting in a selected category; determine, based at least in part on the item-identification data and the selected category, at least one of: the user visited a location within the space associated with items in the selected category; or the user did not visit the location within the space associated with the items in the selected category; responsive to determining (i), generating, by the processor, a first response signal associated with the item; and responsive to determining (ii), generating, by the processor, a second response signal associated with the item including an alert signal associated with an item mismatch.

Additionally, in a variation of this embodiment, receiving the input from the user indicating the item category for the item resulting in the selected category includes selecting the item category from a plurality of categories, each of the plurality of categories being associated with a same genus and a different species of the item.

Moreover, in a variation of this embodiment, receiving the input from the user indicating the item category for the item resulting in the selected category includes selecting the item category from a plurality of categories, each of the plurality of categories being associated with a same appearance and a different chemical composition of the item.

Furthermore, in a variation of this embodiment, the machine vision component is a component of an indicia reader.

Additionally, in a variation of this embodiment, determining the at least one of further includes (iii) the user visited another location within the space associated with items in a non-selected category, and the instructions further cause the one or more processors to: responsive to determining (iii), provide, via the user interface, an option allowing the user to change the item category from the selected category to the non-selected category.

Moreover, in a variation of this embodiment, the instructions further cause the one or more processors to detect an identifying characteristic associated with the user, and the determining the at least one of (i) or (ii) is further based at least in part on the identifying characteristic associated with the user.

Furthermore, in a variation of this embodiment, the instructions further cause the one or more processors to: capture positional data associated with the identifying characteristic during at least some duration that the user is present within the space.

Additionally, in a variation of this embodiment, the one or more processors are component of an indicia reader, and the instructions further cause the one or more processors to: determine the identifying characteristic associated with the user prior to the user being within interactable proximity with the indicia reader; and subsequent to determining the identifying characteristic and before the user being within interactable proximity with the indicia reader, capture the positional data associated with the identifying characteristic.

Moreover, in a variation of this embodiment, the identifying characteristic associated with the user includes at least one of a visual feature associated with the user, an identifier associated with an item carrier operated by the user, or a mobile device profile associated with the user.

Furthermore, in a variation of this embodiment, the first response signal includes transmission of item-identifying data to a host.

Additionally, in a variation of this embodiment, the alert signal includes a prevention of the transmission of the item-identifying data to the host until a release trigger is received at the processor.

Moreover, in a variation of this embodiment, the instructions further cause the one or more processors to determine: (iv) the user removed an item from the space associated with a selected category; (v) the user did not remove an item from the space associated with the selected category; or (vi) the user reached for an item in the space associated with a selected category; and generating the first response signal or the second response signal is responsive to the determination of (iv), (v), or (vi).

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an exemplary point-of-sale (POS) station as it may appear within an exemplary environment in which the techniques provided herein may be implemented.

FIG. 2 illustrates a perspective view of an example indicia reader that may be used to implement the techniques provided herein.

FIG. 3 illustrates a block diagram of an example system for implementing example methods and/or operations described herein including techniques for accurate identification of visually similar items.

FIG. 4 illustrates an example environment in which the techniques provided herein may be implemented.

FIG. 5 illustrates an example user interface display that may be provided in accordance with the techniques provided herein.

FIG. 6 illustrates a block diagram of an example process as may be implemented by the system of FIG. 3, for implementing example methods and/or operations described herein including techniques for accurate identification of visually similar items.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

While certain categories or sub-categories of items may not be visually distinct from one another (e.g., organic produce and non-organic produce, two varieties of the same category of produce, etc.), these items may be stored in different locations of a space (e.g., an organic produce location and a non-organic produce location, a first location for a first produce variety and a second location for a second produce variety). The techniques provided herein may be used to determine and/or verify whether an item is a first category of item (e.g., an organic apple, or another first category of apple, such as a Honeycrisp apple, etc.) or second category of item that is visually similar to the first category of item (e.g., a non-organic apple, or another second category of apple, such as a Fuji apple, etc.) based on whether a user associated with the item visited locations of an environment where the respective categories of items are stored and/or whether the item was removed from a location of the environment where a respective category of items are stored. For instance, the techniques provided herein may determine whether an apple associated with a user is an organic apple or not based on whether the user visited a location where organic apples are stored or not, and/or based on whether the user removed an organic apple from that location.

For example, the techniques provided herein may include monitoring image or video data associated with the locations where each type of item is stored to determine whether the user (or a proxy of the user, such as the user's carrier) has visited each location or not. In another example, the techniques provided herein may include determining whether the user visited a given location or not based on determining whether short-range signals are exchanged between signal transmitters and/or receivers positioned in the location and a signal transmitter and/or receiver of the user's carrier or mobile device. In still another example, the techniques provided herein may include determining whether the user visited a given location or not based on whether an indicia reader positioned in the location reads an indicia affixed to the user's carrier.

Furthermore, in some examples, the techniques provided herein may include additionally, or alternatively, determining whether the item was removed from a particular location or not. For instance, a scale or pressure pad placed below a set of items may be monitored to determine a change in weight or pressure associated with the item being removed from the set of items (e.g., at a time associated with the user visiting the location where the set of items are located). As another example, a beam breaking sensor or a proximity sensor may be monitored to determine whether a user reached into the set of items to remove the item (e.g., at a time associated with the user visiting the location where the set of items are located).

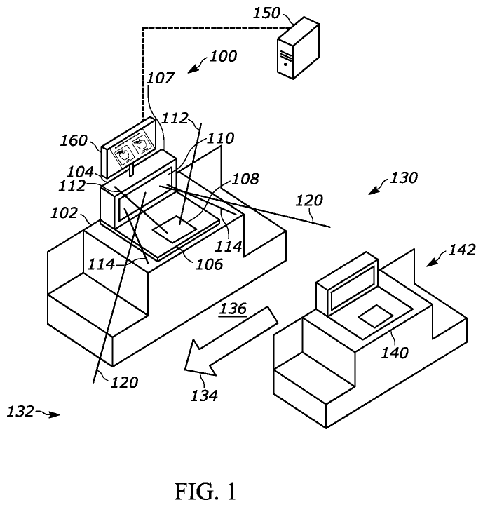

Referring now to FIG. 1, shown therein is an exemplary point-of-sale (POS) station 100 as it may appear within a retail environment such as, for example, a grocery store, a convenience store, etc. The POS station 100 commonly includes a workstation 102 for supporting a barcode reader. In the example shown the barcode reader is illustrated as a bioptic barcode reader 104 having a lower portion 106 that is secured within the workstation 102 and a raised portion 107 extending above the lower portion 106 and above the counter of the workstation 102. The lower portion may include a weigh platter operable to weigh items placed thereon.

The barcode reader of the illustrated embodiment includes two windows for allowing internal imaging components to capture images (also referred to as image data) associated with items presented to the barcode scanner and persons appearing within the region of the POS station. Specifically, the reader 104 includes a generally horizontal window 108 and a generally upright window 110. The generally horizontal window 108 is positioned along a top surface of the lower portion 106 and allows light to be captured over a 2-dimensional field of view (FOV) 112 by an imaging assembly positioned within the barcode reader 104. Similarly, the generally upright window 110 is positioned along a user-facing surface of the raised portion 107 and allows light to be captured over a 2-dimensional FOV 114 by an imaging assembly positioned within the barcode reader 104. It should be appreciated that boundaries of the FOV 112 can be configured in any suitable manner. As such, in some embodiments, the FOV may have an overall diversion angle of less than 70 degrees along the X axis and less than 70 degrees along the Z axis. Additionally, while its central axis extends in a generally vertical direction, it does not have to be normal to the window 108 and may be tilted relative thereto. Furthermore, FOV 112 may be comprised of multiple FOVs combined in some manner to capture image data of objects passing above the lower portion 106.

It should equally be appreciated that boundaries of the FOV 114 can also be configured in any suitable manner. As such, in some embodiments, the FOV may have an overall diversion angle of less than 70 degrees along the X axis and less than 70 degrees along the Y axis. Additionally, while its central axis extends in a generally horizontal direction, it does not have to be normal to the window 110 and may be tilted relative thereto. Furthermore, FOV 114 may be comprised of multiple FOVs combined in some manner to capture image data of objects passing in front of the raised portion 107.

Both FOVs 112 and 114 typically have a limited work range that, in some embodiments, has a maximum of less than 30 inches away from respective window. This distance combined with the boundaries of the FOVs 112 and 114 define a product scanning region of the POS station 100 and more specifically of the barcode reader 104. A product scanning region is a region through with items are normally passed so as to allow the reader 104 to capture one or more images of a barcode affixed to the item and to decode said barcode through image analysis of the captures image(s).

Imaging components used in the barcode reading assembly may include one or more image sensors and respective optics for generating FOVs 112 and 114, and may be viewed as part of a single imaging assembly. Additionally, they may be viewed as part of a single imaging assembly tasked with acquiring image data specifically for purposes of barcode decoding where the image data is generally passed from the image senso(s) to a decoder module and that decoder module decodes the payload that is encoded in a barcode that is present in an image. Thus, this imaging assembly may be referred to as a barcode imaging assembly. To help increase the speed and efficiency of the system, image sensor(s) used for the barcode imaging assembly is, in some embodiments, a monochrome image sensor.

Further to capturing images for purposes of barcode decoding, the POS station includes imaging components for conducting machine vision operations by way of image analysis of images captured over the 2-dimensional FOV 120. In the illustrated embodiment, the imaging components responsible for generating FOV 120 are positioned within the barcode reader 104 and in a way that causes the FOV 120 to extend through the generally upright window 110 in a generally horizontal manner. As with other FOVs, FOV 120 can be configured in any suitable manner. As such, in some embodiments, the FOV may have an overall diversion angle of greater than 70 degrees along the X axis and greater than 45 degrees along the Y axis. Additionally, while its central axis extends in a generally horizontal direction, it does not have to be normal to the window 110 and may be tilted relative thereto. In some embodiments, the central axis of the FOV 120 may be angled in an upward direction along the Y axis between 0 degree and 45 degrees relative to horizontal (Z axis). Additionally, FOV 120 may be comprised of multiple FOVs combined in some manner to capture relevant image data.

While the imaging components responsible for FOV 120 are illustrated as being positioned within the barcode reader 104, in other embodiments those components may be positioned somewhere within the vicinity of the barcode reader 104 such that the FOV 120 may still be oriented in a way that allows appropriate area coverage to be achieved.

As noted earlier, image data captured over the FOV 120 may be used for conducting machine vision operations which, in some embodiments, include analyzing foot traffic in the region of the POS station 100. Consequently, FOV 120 can be expected to have broader coverage than FOVs 112, 114 and can be expected to extend over at least a portion of region in front of the POS station 100 where a user (e.g., a consumer) may be expected to traverse. Additionally, FOV 120 may overlap with the FOVs 112, 114. With this, FOV 120 may have a working range that is great than FOVs 112, 114, and in some embodiments extends up to, for example, 36 in, 48 in, 60 in, 72 in, 84 in, 120 in.

Imaging components used in the vision imaging assembly may include one or more image sensors and respective optics for generating FOV 120, and may be viewed as part of a single imaging assembly. Additionally, they may be viewed as part of a single imaging assembly tasked with acquiring image data specifically for purposes of machine vision image analysis where the image data is generally passed from the image senso(s) to an analyzer module and that analyzer module provides analysis results based on image data presented in the image. Thus, this imaging assembly may be referred to as a vision imaging assembly. To help capture the necessary details for vision analysis, the sensor(s) used for the vision imaging assembly is, in some embodiments, a colored image sensor.

Each of the barcode imaging assembly and the vision imaging assembly may use an imaging sensor that is a solid-state device, for example, a CCD or a CMOS imager, having a one-dimensional array of addressable image sensors or pixels arranged in a single row, or a two-dimensional array of addressable image sensors or pixels arranged in mutually orthogonal rows and columns, and operative for detecting return light captured by a lens group over a respective imaging FOV along an imaging axis that is normal to the substantially flat image sensor. The lens group is operative for focusing the return light onto the array of image sensors (also referred to as pixels) to enable the image sensor, and thereby the imaging assembly, to form a digital image. In particular, the light that impinges on the pixels is sensed and the output of those pixels produce image data that is associated with the environment that appears within the FOV. This image data may be processed by an internal controller/processor (e.g., by being sent to a decoder which identifies and decodes decodable indicia captured in the image data) and/or it may be sent upstream to the host 150 for processing thereby.

The POS station 100 is generally configured in a manner where the POS station 100 has an ingress region 130, an egress region 132, and a direction of travel 134. In typical circumstances, the area between the ingress region 130 and the egress region 132 will be a lane 136 that is constrained by the workstation 102 of the subject POS station 100 and a neighboring workstation 140 of a neighboring POS station 142. In this manner, consumers leaving a venue generally pass through the lane 136 in the direction 134.

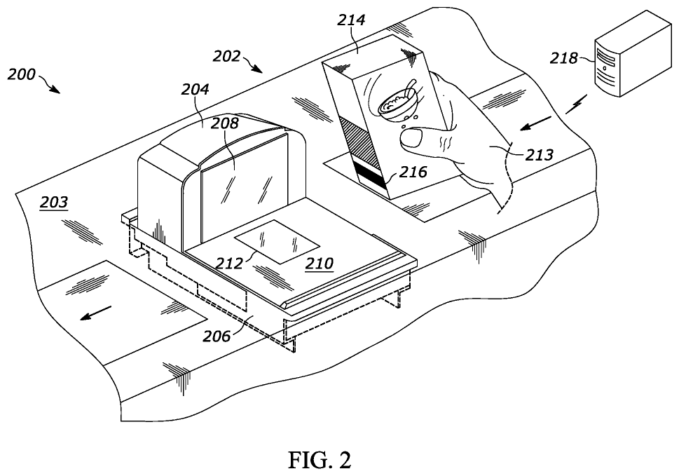

At a higher level, embodiments described herein may be used in any variety of indicia readers. For example, FIG. 2 illustrates an exemplary bioptic indicia reader 200 that may be used in a retail venue, where said reader may employ the concepts described herein. In the illustrated example, the bioptic indicia reader 200 is shown as part of a POS station 100 discussed above, having the bioptic indicia reader 200 positioned within a workstation counter 203. Generally, the indicia reader 200 includes an upper housing 204 (also referred to as an upper portion, upper housing portion, or tower portion) and a lower housing 206 (also referred to as a lower portion, lower housing portion, or platter portion). The upper housing 204 can be characterized by an optically transmissive window 208 positioned therein along a generally vertical plane and one or more field of view (FOV) which passes through the window 208 and extends in a generally lateral direction. The lower housing 206 can be characterized by a weigh platter 210 or a cover that includes an optically transmissive window 212 positioned therein along a generally horizontal (also referred to as a transverse) plane and one or more FOV which passes through the window 212 and extends in a generally upward direction. The weigh platter 210 is a part of a weigh platter assembly that generally includes the weigh platter 210 and a scale (or load cell) configured to measure the weight of an object placed the top surface of the weight platter 210. By that virtue, the top surface of the weight platter 210 may be considered to be the top surface of the lower housing 206 that faces a product scanning region there above.

In operation, a user 213 generally passes an item 214 across a product scanning region of the indicia reader 200 in a swiping motion in some general direction, which in the illustrated example is right-to-left. A product scanning region can be generally viewed as a region that extends above the platter 210 and/or in front of the window 208 where barcode reader 200 is operable to capture image data of sufficient quality to perform imaging-based operations like decoding a barcode that appears in the obtained image data. It should be appreciated that while items may be swiped past the indicia reader 200 in either direction, items may also be presented into the product scanning region by means other than swiping past the window(s). When the item 214 comes into the any of the fields of view of the reader, the indicia 216 on the item 214 is captured and decoded by the indicia reader 200, and corresponding data (e.g., the payload of the indicia) is transmitted to a communicatively coupled host 218 (commonly comprised of a point of sale (POS) terminal).

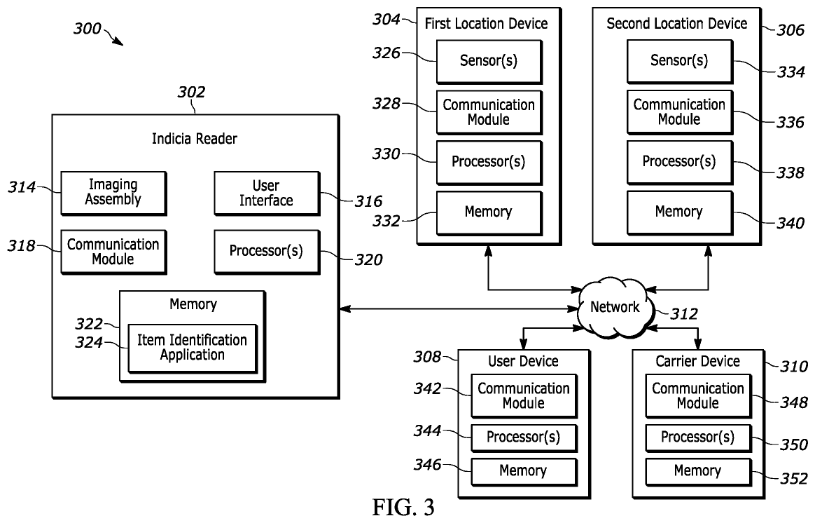

FIG. 3 illustrates an example system 300 where embodiments of the present invention may be implemented, such as techniques for accurate identification of visually similar items. The system 300 may include a computing device 302 (which may be an indicia reader device, such as indicia reader 200 discussed with respect to FIG. 2 above, e.g., as part of a POS station 100 as discussed with respect to FIG. 1 above), as well as one or more of: a computing device 304 associated with a first location, a computing device 306 associated with a second location, a computing device 308 (such as, e.g., a smart phone, smart watch, or other mobile device) associated with a user (e.g., a customer in a retail environment), and/or a computing device 130 associated with the user's carrier (e.g., a shopping cart, a shopping basket, a tote bag, or other carrier associated with and/or provided by a retail environment). The computing device 302 may communicate with the first location computing device 304, second location computing device 306, user computing device 308, and/or carrier computing device 310 via a wired or wireless network 312. Additionally, in some examples, the first location computing device and/or the second location computing device may communicate with the user computing device 308 and/or the carrier computing device 310 via one or more short range signals, as discussed in greater detail below.

The computing device 302 may include an imaging assembly 314 configured to capture images of items, users, carriers associated with users, etc., a user interface 316 configured to receive inputs from users and provide outputs to users (e.g., visibly via a display screen, audibly via one or more speakers, etc.), a communication module 318 via which the computing device 302 may communicate with the first location computing device 304, second location computing device 306, user computing device 308, and/or carrier computing device 310. Furthermore, the computing device 302 may include one or more processors 320 and a memory 322.

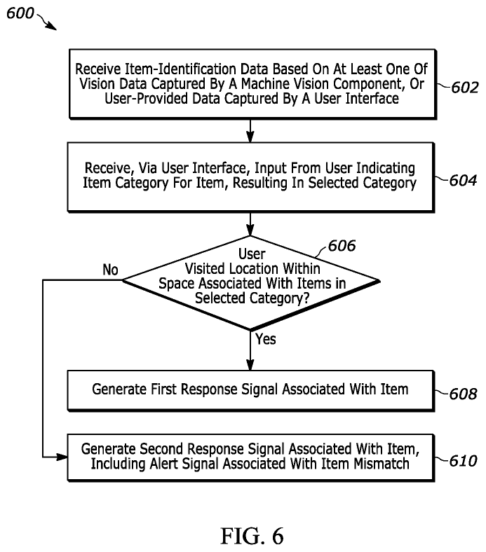

The processors 320 may interact with the memory 322 to obtain, for example, machine-readable instructions stored in the memory 322 corresponding to, for example, the operations represented by the flowcharts of this disclosure, including those of FIG. 6. In particular, the instructions stored in the memory 322, when executed by the processors 320, may cause the processor 320 to receive and analyze signals generated by the imaging assembly 314, the user interface 316, and the communication module 318.

For example, the memory 322 may include an item identification application 324. In some examples, executing the item identification application 324 may include receiving item-identifying information from a user, e.g., via the user interface 316. For instance, a user may make a selection via the user interface 316 to identify the item specifically, or to identify a category or sub-category of item. Additionally or alternatively, in some examples, executing the item identification application 324 may include causing the imaging assembly 314 to capture an image of an item (e.g., an item in a product scanning region associated with a POS), or otherwise receiving or obtaining a captured image of the item in the product scanning location from the imaging assembly 314 or from another device in communication with the imaging assembly 314. The item identification application 324 may use image analysis techniques to analyze the captured image of the item to identify the item specifically, or to identify a category or sub-category of item. In some examples, the item identification application 324 may determine that the captured image of the item corresponds to a particular category of item, but cannot determine which of a plurality of sub-categories of the category of item appear in the captured image. For example, the item identification application 324 may determine that the item in the captured image belongs to a particular category of fruit, such as an apple or a banana. But the item identification application 324 may be unable to determine whether the item is an organic apple or a non-organic apple (or an organic banana or a non-organic banana, etc.), or whether the item belongs to a particular category of apple (e.g., a Honeycrisp apple or a Fuji apple).

In some examples, the item identification application 324 may provide a display, via the user interface 316, requesting that a user (e.g., a customer or retail employee at a point of sale in a retail environment) provide input confirming and/or indicating the item corresponds to the first category or second category of item. For instance, in some examples, this display may be provided when the item identification application 324 is unable to determine whether the item corresponds to a first category or a second category of item (or a first or second sub-category of item) based on data captured by the imaging assembly 314. In other examples, the item identification application 324 may provide the display regardless of such data captured by the imaging assembly 314, or in the absence of such data captured by the imaging assembly 314.

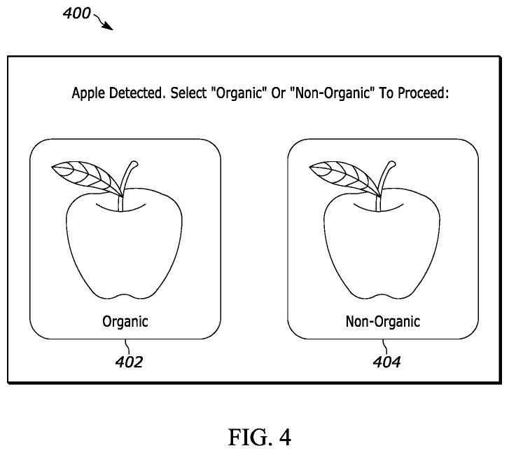

For example, FIG. 4 illustrates an example of such a user interface display 400. As shown at FIG. 4, the user interface display 400 may prompt a user to select between an interactive control 402 indicating a first category of item (“organic apple”) and an interactive control 404 indicating a second category of item (“non-organic apple”). The user may select one of the interactive controls 402, 404, and the item identification application 324 may receive a signal from the user interface 316 indicating which of the interactive controls 402, 404 was selected.

In some examples, the item identification application 324 may send a first response signal to a host device associated with the item category that is selected via the interactive control 402 or the interactive control 404. For example, the first response signal may cause the host device to proceed to process a transaction associated with the selected item category. For instance, in some examples, if the user selects the interactive control 402 that is associated with a more expensive item category (e.g., “organic apple”), the item identification application 324 may send the first response signal to the host. In contrast, if the user selects the interactive control 404 that is associated with a less expensive item category (e.g., “non-organic apple”), the item identification application 324 may take additional steps to verify the item category before sending the first response signal to the host. In other examples, the item identification application 324 may take additional steps to verify the item category before sending the first response signal to the host, regardless of whether the interactive control 402 is selected or the interactive control 404 is selected. Moreover, in still other examples, the item identification application 324 may not present the user interface display 400 or receive inputs via the interactive controls 402 and 404, and may take additional steps to verify the item category after being unable to determine the item category by analyzing the image.

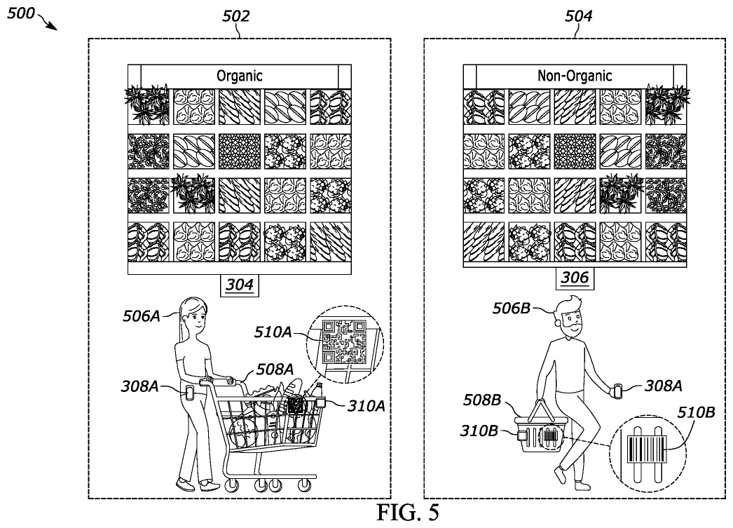

For instance, in some examples, the item identification application 324 may verify the item category based on determining whether the user visited a location associated with the item category. Referring now to FIG. 5, an example space or environment 500 may include a first location 502 associated with a first category of item (e.g., “organic produce”, “organic apples,” “organic bananas,” etc.), and a second location 504 associated with a second category of item (e.g., “non-organic produce,” “non-organic apples,” “non-organic bananas,” etc.). The example environment 500 may include additional locations associated with additional categories of items, not shown at FIG. 5, in some embodiments. The item identification application 324 may, for instance, determine whether a user 506A, 506B (or a proxy of the user 506A, 506B, such as a respective carrier 508A, 508B) has visited the first location 502 or the second location 504. For example, the item identification application 324 may determine whether a user 506A, 506B has visited the first location 502 or the second location 504, as well as dates/times at which the user 506A, 506B has visited the first location 502 or the second location 504, based on data received from the first location device 304, the second location device 306, the user device 308, and/or the carrier device 310. Furthermore, in some examples, the item identification application 324 may determine whether items were removed from the first location 502 or the second location 504 at times corresponding to the dates/times at which the user 506A, 506B visited the corresponding locations, based on data received from the first location device 304 and/or the second location device 306.

Based on determining whether a user 506A, 506B visited the first location 502 associated with the first item category or a second location 504 associated with the second item category (and, in some cases, based on determining whether the item was removed from the first location 502 or the second location 504 at a time corresponding to the user's visit), the item identification application 324 may determine whether the item is likely the first category of item or the second category of item. For example, if the user 506A visited the first location 502 (or did not visit the second location 504), the item may be more likely to belong to the first category of item. Similarly, if the user 506B visited the second location 504 (or did not visit the first location 502), the item may be more likely to belong to the second category of item. Furthermore, if an item was determined to be removed from the first location 502 at the time that the user 506A visited the first location 502, the item may be more likely to belong to the first category of item. Similarly, if an item was determined to be removed from the second location 504 at the time that the user 506B visited the second location 504, the item may be more likely to belong to the second category of item.

Based on verifying the item category, the item identification application 324 may send a first response signal to the host, including an indication of the verified category of item. In some examples, if the item is initially identified incorrectly, the item identification application 324 may further perform one or more mitigation actions. For example, in some examples, the mitigation actions may include capturing, by the imaging assembly 314 (or the sensors 326, 334), an image of an individual present at the computing device 302 at the time the item was identified incorrectly. Furthermore, in some examples, the mitigation actions may include triggering an audible or visible alert, e.g., the user interface 316. Additionally, in some examples, the mitigation actions may include sending a second response signal to the host, which may cause the host to, for instance, pause a transaction associated with the item, generate an alert to an employee associated with the computing device 302, preventing future transactions of the individual present at the computing device 302 at the time the item was identified incorrectly, mark a receipt of a transaction associated with the item, etc.

The first location device 304 may be positioned within the first location 502 (or may be otherwise positioned proximate to the first location 502) and may be configured to capture data associated with the user 506A, the carrier 508A, the user device 308A, and/or the carrier device 310A, if/when the user 506A, the carrier 508A, the user device 308A, and/or the carrier device 310A is present in the first location 502. Similarly, the second location device may be positioned within or proximate to the second location 504 and may be configured to capture data associated with the user 506B, the carrier 506B, the user device 308B, and/or the carrier device 310B, if/when the user 506B, the carrier 508B, the user device 308B, and/or the carrier device 310B is present in the second location 504.

For instance, the first location device 304 may include one or more sensors 326, and/or a communication module 328. The first location device 304 may further include one or more processors 330 and a memory 332. The processors 330 may interact with the memory 332 to obtain, for example, machine-readable instructions stored in the memory 332 corresponding to, for example, the operations represented by the flowcharts of this disclosure, including those of FIG. 6. In particular, the instructions stored in the memory 332, when executed by the processors 330, may cause the processors 330 to receive and analyze signals, data, etc., captured by the one or more sensors 326 and/or the communication module 328. In some examples, the instructions stored on the memory 332 may cause the processors 330 to send the signals, data, etc. captured by the one or more sensors 326 and/or the communication module 328 to the computing device 302 for analysis by the item identification application 324 or another application stored on the memory 322, while in other examples, the first location computing device 304 may perform part or all of the analysis of the signals, data, etc., and may send the results of the analysis to the item identification application 324 or another application stored on the memory 322 of the computing device 302.

For instance, the one or more sensors 326 associated with the first location device 304 may include one or more cameras positioned to capture image data associated with the first location 502. For example, the one or more cameras may capture image data associated with a user 506A who visits the first location 502, and the instructions stored on the memory 332 may cause the processors 330 to analyze the image data to identify the user 506A, or to otherwise identify characteristics associated with the user 506A. For example, the instructions stored on the memory 332 may cause the processors 330 to analyze the image data to compare an image of the user 306A (and/or the carrier 308A) as captured by the one or more cameras positioned to capture image data associated with the first location 302 to an image of the user and/or carrier as captured by the imaging assembly 314. As another example, the one or more cameras may capture image data associated with a carrier 508A (such as a shopping cart) used by the user 506A, which may include, for instance, image data associated with an indicia 510A affixed to the carrier 508A, and the instructions stored on the memory 332 may cause the processors 330 to analyze the image data to identify the carrier 508A, and/or to decode the indicia 510A to identify a payload of the indicia that is associated with an identification of the carrier 508A.

Additionally, in some examples, the one or more sensors 326 associated with the first location device 304 may include sensors configured to detect indications of items being removed from the first location 502. For instance, the one or more sensors 326 may include a weighing scale beneath the items of the first location 502, which may detect reductions in weight that are associated with items of the first location 502 being removed from the weighing scale. For example, the instructions stored on the memory 332 may cause the processors 330 to analyze changes in weight to identify dates and/or times at which items were likely removed from the first location 502. As another example, the one or more sensors 326 may include motion sensors, proximity sensors, and/or beam breaking sensors associated with the items of the first location, which may detect the movement of items in the first location 502 and/or appendages of users 506A in the first location reaching toward and/or removing items of the first location 502. For instance, the instructions stored on the memory 332 may cause the processors 330 to analyze data captured by the motion sensors, proximity sensors, and/or beam breaking sensors to identify dates and/or times at which items were likely removed from the first location 502.

In some examples, the communication module 328 of the first location device 304 may send and/or receive signals (e.g., short range signals) from a user device 308 (e.g., a user device 308A) and/or a carrier device 310 (e.g., a carrier device 310A), and the instructions stored on the memory 332 may cause the processors 330 to analyze the signals to identify the user device 308A and/or the carrier device 310A, and/or a respective user 506A and/or carrier 508A associated therewith. Furthermore, in some examples, the communication module 328 of the first location device 304 may send indications of any users 506A, carriers 508A, user devices 308A and/or carrier devices 310A identified based on sensor data and/or signal data, to the computing device 302, for processing by the item identification application 324 or another application of the computing device 302. In some examples, these indications may include indications of dates/times at which the data was captured and/or the signals were received. Similarly, in some examples, the communication module 328 of the first location device may send indications of items that were likely removed from the first location 502, and/or dates and/or times at which items were likely removed from the first location 502, to the computing device 302 for processing by the item identification application 324 or another application of the computing device 302.

The second location device 306 may, similarly, include one or more sensors 334 and/or one or more communication modules 336, as well as one or more processors 338 and a memory 340, all of which operate in a similar manner as the sensors 326, communication modules 328, processors 330, and memory 332 of the first location device, with respect to items, users 506B, carriers 508B, user devices 308B, carrier devices 310B, and/or carrier indicia 510B within the second location 504 rather than items, users 506A, user devices 508A, carrier devices 310A, and/or carrier indicia 510A within the first location 502.

The user device 308 (e.g., the user devices 308A, 308B as shown at FIG. 5) of FIG. 3 may include a communication module 342 configured to communicate with the first location device 304 and/or the second location device 306, one or more processors 344, and a memory 346. The processors 344 may interact with the memory 346 to obtain, for example, machine-readable instructions stored in the memory 346 corresponding to, for example, the operations represented by the flowcharts of this disclosure, including those of FIG. 6. In particular, the instructions stored in the memory 346, when executed by the processors 344, may cause the processors 344 to send signals via the communication module 342, and/or to analyze signals received by the communication module 342. For instance, in some examples, the instructions stored on the memory 346 may cause the processors 344 to receive signals from the first location device 304 and/or the second location device 306 and analyze the signals from the first location device 304 and/or the second location device 306 to identify the respective first location device 304 and/or the second location device 306 from which the signals were received. The one or more processors 344 may further log dates and/or times associated with the receipt of signals from the first location device 304 and/or the second location device 306. The one or more processors 344 may send indications of the signals received from the first location device and/or second location device 306, and/or dates and/or times at which the signals were received, to the computing device 302 for further processing by the item identification application 324 or another application.

The carrier device 310 (e.g., the carrier devices 310A, 310B as shown at FIG. 5) of FIG. 3 may include a communication module 350, one or more processors 352, and a memory 354, which may operate in a similar manner as the communication module 344, one or more processors 344 and/or memory 346 of the user device 308, with respect to sending, receiving, and/or analyzing signals from the first location device 304 and/or second location device 306, and with respect to sending indications of such signals, and/or dates and times associated with such signals, to the computing device 302 for further processing by the item identification application 324 and/or other applications of the computing device 302.

FIG. 6 illustrates a block diagram of an example process 400 as may be implemented by the system 300 of FIG. 3 for implementing example methods and/or operations described herein including techniques for accurate identification of visually similar items.

At block 602, item-identification data may be received at a processor. For instance, the item-identification data may be based on vision data captured by a machine vision component, and/or may be based on user-provided data captured by a user interface. For instance, the processor, and/or the machine vision component, may be components of an indicia reader.

At block 604, input from a user may be received at the processors, via a user interface. The input from the user may indicate an item category for the item, resulting in a selected category. For instance, the input may include a selection of the item category from a plurality of categories that are each associated with the same genus, but different respective species of items. As another example, the input may include a selection of the item category from a plurality of categories that are each associated that are each associated with the same item appearance, but different respective chemical compositions of items.

At block 606, a determination may be made by the processor, as to whether the user visited a location, within a space, that is associated with items in the selected category. For instance, the method 600 may further include detecting an identifying characteristic associated with the user, and determining whether the user visited the location within the space that is associated with items in the selected category based on the identifying characteristic associated with the user. For instance, the identifying characteristic associated with the user may include at least one of a visual feature associated with the user, an identifier associated with an item carrier operated by the user, and/or a mobile device profile associated with the user. In some examples, positional data associated with the identifying characteristic may be captured during at least some duration that the user is present in the space. For instance, the identifying characteristic associated with the user may be determined prior to the user being within interactable proximity with the indicia reader, and the positional data may be captured subsequent to determining the identifying characteristic but prior to the user being within interactable proximity with the indicia reader.

If the user visited a location within the space that is associated with items in the selected category (block 606, YES), a first response signal associated with the item may be generated by the processor, at block 608. For example, the first response signal may include a transmission of item-identifying data to a host.

If the user did not visit the location within the space that is associated with items in the selected category (block 606, NO), a second response signal associated with the item may be generated by the processor, at block 610. The second response signal may include an alert signal associated with an item mismatch. For instance, the alert signal may include a prevention of the transmission of item-identifying data to the host until a release trigger is received at the processor.

In some examples, the method 600 may include determining whether the user removed an item from the location within the space that is associated with items in the selected category or not, and/or whether the user reached into the location within the space that is associated with items in the selected category or not. In such examples, the determination of whether to generate the first response signal or the second response signal may be further based on whether the user removed an item from the location within the space that is associated with items in the selected category or not, and/or whether the user reached into the location within the space that is associated with items in the selected category or not.

Moreover, in some examples, the method 600 may further include determining whether the user visited another location within the space that is associated with items in a non-selected category of the plurality of categories. If the user visited another location within the space that is associated with items in the non-selected category of the plurality of categories, the method 600 may further include providing an option, via the user interface, allowing the user to change the item category from the selected category to the non-selected category.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method of item processing within a space comprising:
receiving, at a processor, item-identification data, the item-identification data being based on at least one of vision data captured by a machine vision component or a user-provided data captured by a user interface;
receiving, at the processor and via the user interface, input from a user indicating an item category for the item resulting in a selected category;
determining, based at least in part on the item-identification data and the selected category, at least one of:
(i) the user visited a location within the space associated with items in the selected category; or
(ii) the user did not visit the location within the space associated with the items in the selected category;
responsive to determining (i), generating, by the processor, a first response signal associated with the item; and
responsive to determining (ii), generating, by the processor, a second response signal associated with the item including an alert signal associated with an item mismatch.

2. The method of claim 1, wherein the receiving the input from the user indicating the item category for the item resulting in the selected category includes selecting the item category from a plurality of categories, each of the plurality of categories being associated with a same genus and a different species of the item.

3. The method of claim 1, wherein the receiving the input from the user indicating the item category for the item resulting in the selected category includes selecting the item category from a plurality of categories, each of the plurality of categories being associated with a same appearance and a different chemical composition of the item.

4. The method of claim 1, wherein the machine vision component is a component of an indicia reader.

5. The method of claim 1, wherein the determining the at least one of further includes (iii) the user visited another location within the space associated with items in a non-selected category, and wherein the method further includes, responsive to determining (iii), providing, via the user interface, an option allowing the user to change the item category from the selected category to the non-selected category.

6. The method of claim 1, further comprising detecting, at the processor, an identifying characteristic associated with the user, and
wherein the determining the at least one of (i) or (ii) is further based at least in part on the identifying characteristic associated with the user.

7. The method of claim 6, further comprising:
capturing positional data associated with the identifying characteristic during at least some duration that the user is present within the space.

8. The method of claim 7, wherein the processor a component of an indicia reader, and
wherein the method further comprises:
determining the identifying characteristic associated with the user prior to the user being within interactable proximity with the indicia reader; and
subsequent to determining the identifying characteristic and before the user being within interactable proximity with the indicia reader, capturing the positional data associated with the identifying characteristic.

9. The method of claim 6, wherein the identifying characteristic associated with the user includes at least one of a visual feature associated with the user, an identifier associated with an item carrier operated by the user, or a mobile device profile associated with the user.

10. The method of claim 1, wherein the first response signal includes transmission of item-identifying data to a host.

11. The method of claim 10, wherein the alert signal includes a prevention of the transmission of the item-identifying data to the host until a release trigger is received at the processor.

12. The method of claim 1, further comprising determining:
(iv) the user removed an item from the location within the space associated with a selected category;
(v) the user did not remove an item from the location within the space associated with the selected category; or
(vi) the user reached for an item in the location within the space associated with a selected category;
wherein generating the first response signal or the second response signal is responsive to the determination of (iv), (v), or (vi).

13. A system for item processing within a space comprising:
one or more processors; and
a memory storing instructions that, when executed by the one or more processors, cause the one or more processors to:
receive item-identification data, the item-identification data being based on at least one of vision data captured by a machine vision component or a user-provided data captured by a user interface;
receive, via the user interface, input from a user indicating an item category for the item resulting in a selected category;
determine, based at least in part on the item-identification data and the selected category, at least one of:
(i) the user visited a location within the space associated with items in the selected category; or
(ii) the user did not visit the location within the space associated with the items in the selected category;
responsive to determining (i), generating, by the processor, a first response signal associated with the item; and
responsive to determining (ii), generating, by the processor, a second response signal associated with the item including an alert signal associated with an item mismatch.

14. The system of claim 13, wherein the receiving the input from the user indicating the item category for the item resulting in the selected category includes selecting the item category from a plurality of categories, each of the plurality of categories being associated with a same genus and a different species of the item.

15. The system of claim 13, wherein the receiving the input from the user indicating the item category for the item resulting in the selected category includes selecting the item category from a plurality of categories, each of the plurality of categories being associated with a same appearance and a different chemical composition of the item.

16. The system of claim 13, wherein the machine vision component is a component of an indicia reader.

17. The system of claim 13, wherein the determining the at least one of further includes (iii) the user visited another location within the space associated with items in a non-selected category, and wherein the instructions further cause the one or more processors to:
responsive to determining (iii), provide, via the user interface, an option allowing the user to change the item category from the selected category to the non-selected category.

18. The system of claim 13, wherein the instructions further cause the one or more processors to detect an identifying characteristic associated with the user, and
wherein the determining the at least one of (i) or (ii) is further based at least in part on the identifying characteristic associated with the user.

19. The system of claim 18, wherein the instructions further cause the one or more processors to:
capture positional data associated with the identifying characteristic during at least some duration that the user is present within the space.

20. The system of claim 19, wherein the one or more processors are component of an indicia reader, and
wherein the instructions further cause the one or more processors to:
determine the identifying characteristic associated with the user prior to the user being within interactable proximity with the indicia reader; and
subsequent to determining the identifying characteristic and before the user being within interactable proximity with the indicia reader, capture the positional data associated with the identifying characteristic.

21. The system of claim 18, wherein the identifying characteristic associated with the user includes at least one of a visual feature associated with the user, an identifier associated with an item carrier operated by the user, or a mobile device profile associated with the user.

22. The system of claim 13, wherein the first response signal includes transmission of item-identifying data to a host.

23. The system of claim 22, wherein the alert signal includes a prevention of the transmission of the item-identifying data to the host until a release trigger is received at the processor.

24. The system of claim 13, wherein the instructions further cause the one or more processors to determine:
(iv) the user removed an item from the location within the space associated with a selected category;
(v) the user did not remove an item from the location within the space associated with the selected category; or
(vi) the user reached for an item in the location within the space associated with a selected category;
wherein generating the first response signal or the second response signal is responsive to the determination of (iv), (v), or (vi).
